(19) United States
(12) Patent Application Publication
(10) Pub. No.: US 2009/0126256 A1
(43) Pub. Date: May 21, 2009

(54) MODULAR FISHING LURE SYSTEM

(75) Inventor: Ronald Gregory, Hong Kong (HK)

Correspondence Address: Ryan D. Benson;Stoel Rives LLP, Suite 1100, 201 S. Main Street, Salt Lake City, UT, 84111, US

(73) Assignee: ENVISAGE PRODUCTS COMPANY, LTD., Hong Kong (HK)

(21) Appl. No.: 11/942,591

(22) Filed: Nov. 19, 2007

(51) Int. Cl. A01K 85/12; A01K 85/00

(52) U.S. Cl. 43/42.09; 43/42.19; 43/42.15; 43/42.2

(57) ABSTRACT

The present invention is directed to a modular fishing lure system having components which allow a user to create customizable fishing lures with greater flexibility and creativity while also being modifiable in the fishing environment in a manner that the user can alter the lure as needed while the user is fishing. The fishing lure system can include a propeller which provides desired action and movement of both the lure and the water surrounding the lure to entice fish to attack the fishing lure. The fishing lure system can include color components, which are provided to allow the user to select different colors and patterns in the body of the fishing lure. A secondary lure is provided in connection with the primary lure which trails behind the primary lure. A hook is attached to the lure in a manner such that when a fish strikes the hook, the hook is released from the body of the fishing lure while still being held by the primary line or a leader which is attached to the primary line which can reduce damage or accidental release of the fish as the fish is being reeled into the fisherman.

### BACKGROUND OF THE INVENTION

1. The Field of the Invention

The present invention relates to fishing lures. In more particular, the present invention relates to a modular fishing lure system allowing a user to create customizable fishing lures.

2. The Relevant Technology

Artificial fishing lures have long been used in place of bait, nets, or the like to catch a variety of different types of fish in many different angling environments. Typically, fishing lures are utilized in primarily sport fishing in which the user can enjoy the thrill of luring in individual fish utilizing a variety of different fishing strategies. Traditionally, fishing lures are purchased in stock configurations from fishing lure manufacturers. Stock fishing lure configurations provide a variety of different colors and shapes allowing a user to switch between different lures in the event that one lure is unsuccessful, or to catch different sizes or numbers of fish in a particular ocean environment, lake, or stream. The difficulty of using stock fishing lures is that the fisherman's creativity and strategies for catching a particular fish are limited by the choice and selection of fishing lures which have been purchased by the fisherman. As a result, where a user feels that a different color, size, shape, or action of the lure is needed, in the event that the user does not have such a fishing lure in his/her possession, the user does not have the opportunity to utilize such strategies and/or lures absent driving to a store and purchasing additional fishing lures. Additionally, the cost of purchasing multiple fishing lure combinations can be expensive for the average outdoorsman and as a result unnecessarily restrictive.

### BRIEF SUMMARY OF THE INVENTION

The present invention is directed to a modular fishing lure system having components which allow a user to create customizable fishing lures with greater flexibility and creativity while also being modifiable in the fishing environment in a manner that the user can alter the lure as needed while the user is fishing.

According to one embodiment, the modular fishing lure system includes components of the body of the fishing lure and also components for providing the action of the lure as the lure passes through water. Additionally, variable hook units can be utilized as an additional variable to attract fish. According to one embodiment of the present invention, a propeller is provided to be utilized with the body of the fishing lure. The propeller provides desired action and movement of both the lure and the water surrounding the lure to entice fish into attacking the fishing lure. Additionally, a user can select from various propeller designs to customize the fishing lure. According to another embodiment of the present invention, components are provided to allow the user to select multiple colors and patterns of the body of the system. According to one embodiment, a fill or glitter is provided which can be utilized to fill a tube to provide color to the body of the fishing lure. According to another embodiment, one or more colored beads are provided that can be utilized within and without a tube or other body component of the fishing lure. According to another embodiment of the present invention, the alternative fishing lure bodies are provided which have varying degrees of flexibility and/or rigidity which can be selected by the user to vary the amount of movement or action of the fishing lure body.

According to one embodiment of the present invention, a colored fluid is provided. The fluid can be utilized in connection with a scent which will further attract fish to attack the fishing lure. Additionally, the scent can be integrally combined with one or more components of the fishing lure system. According to another embodiment of the present invention, a secondary lure is provided in connection with the primary lure. The secondary lure can comprise a buoyant lure which trails behind the primary lure. Typically, the secondary lure has a unique action and configuration which can lure a secondary fish. Additionally, the secondary lure can attract a primary fish which may not be attracted to the configuration of the primary lure. According to another embodiment of the present invention, the hook is attached to the lure in a manner such that when a fish strikes the hook, the hook is released from the body of the fishing lure while still being held by the primary line or a leader which is attached to the primary line which can reduce damage or accidental release of the fish as the fish is being reeled into the fisherman.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a fishing lure which can be formed utilizing the modular fishing lure system, according to one embodiment of the present invention.

FIG. 2 illustrates components of a modular fishing lure system which can be utilized by an angler to create a customizable fishing lure having different configurations and components, according to one aspect of the present invention.

FIG. 3 illustrates an alternative embodiment of a fishing lure created utilizing the components of the modular fishing lure system of FIG. 2.

FIG. 4 is a cross-sectional view of the fishing lure illustrating the components of the fishing lure and a mechanism for providing color variation in the body of the fishing lure.

FIG. 5 illustrates a fishing lure which has attracted and hooked a fish, illustrating the manner in which the releasable hook releases from the body of the fishing lure.

FIG. 6 is an alternative view of a customizable fishing lure created utilizing the modular fishing lure system in which a secondary lure is utilized in connection with a primary lure.

FIG. 7 illustrates a fishing lure system with interchangeable components according to one embodiment of the present invention.

### DETAILED DESCRIPTION OF THE PREFERRED EMBODIMENTS

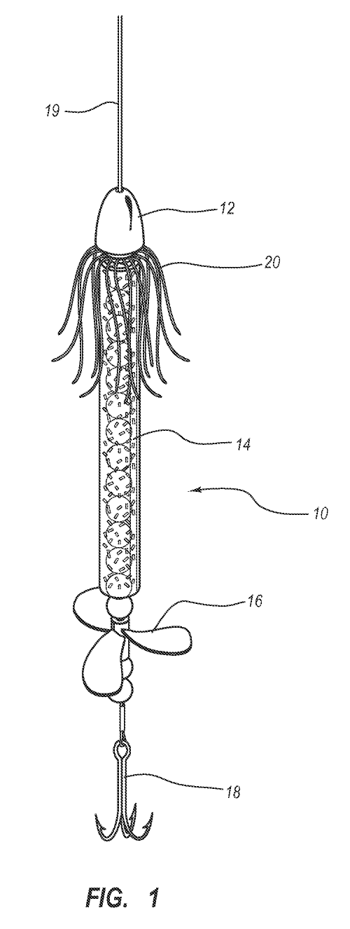

FIG. 1 illustrates a fishing lure 10, according to one embodiment of the present invention. Fishing lure 10 is constructed by an angler utilizing components of a modular fishing lure system. Fishing lure 10 comprises a head 12, a body 14, a propeller 16, a hook 18, and a leader 19.

Head 12 is positioned at the proximal end of fishing lure 10. Head 12 has a conical configuration which is adapted to facilitate movement of lure 10 through the water. Body 14 is positioned distally to head 12. Body 14 comprises the portion of the fishing lure which provides a color pattern and/or specified movement of the fishing lure through the water. According to one embodiment of the present invention, body 14 will generally have the appearance and movement of a small fish or minnow in the water. In the present embodiment, body 14 comprises a resilient tube which can be filled with a color medium, such as glitter, beads, fluid, or the like. The resilient configuration of body 14 allows for a natural movement of lure 10, while also providing some flexibility, which can limit breakage of fishing lure 10 once fishing lure 10 is struck by a fish. Additionally, tube 10 can be sufficiently rigid, to minimize awkward or unnatural movement of the fishing lure.

A propeller 16 is positioned distally to body 14. Propeller 16 interfaces with the water as fishing lure 10 is pulled through the water in a manner that results in rotation of propeller 16. Additionally, propeller 16 results in movement or action of fishing lure 10 that resembles that of the prey of a typical fish or a potential enemy of the fish in such a manner that a fish will attack fishing lure 10. Propeller 16 also results in turbulence in the water through which fishing lure 10 is being drawn. Turbulence in the water conveys the presence of fishing lure 10 to a fish. According to alternative embodiments of the present invention, the propeller can be located in the front, middle, end and/or other positions within the fishing lure. Hook 18 is positioned at the distal most end of fishing lure 10. Hook 18 is adapted to secure the fish to the lure when the fish touches, swallows, or otherwise comes in contact with hook 18. Hook 18 can be selected from a variety of configurations and designs including bucktail, worm treble, fly or other known fishing hook designs. According to one embodiment of the present invention, a selection of different fishing hook designs are provided.

A variety of other additional components can be provided in connection with fishing lure 10. For example, in the illustrated embodiment, an ornamental flange 20 is positioned between head 12 and body 14. Ornamental flange 20 provides additional color and movement to fishing lure 10 in a manner to entice a fish to attack fishing lure 10. Additionally, a number of beads, connection mechanisms, and the like are provided. A leader 19 is threaded along the entire length of fishing lure 10 and is connected to hook 18. Leader 19 provides direct securement with hook 18 such that when a fish is caught using hook 18, hook 18 can be released relative to the other components of fishing lure 10 while still being effectively secured to leader 19. In this manner, lateral twisting, movement, yanking, or other manipulation of the fish minimizes the potential that the interaction between hook 18 and other components of fishing lure 10 could bend or damage hook 18 in a manner that could result in the accidental releasing of the fish from the fishing lure. Additionally, the releasing of hook 18 from the other components of fishing lure 10 minimizes the potential that hook 18 may accidentally become dislodged from the fish or otherwise result in accidental releasing of the fish. According to one embodiment of the present invention, leader 19 comprises a portion of the primary line.

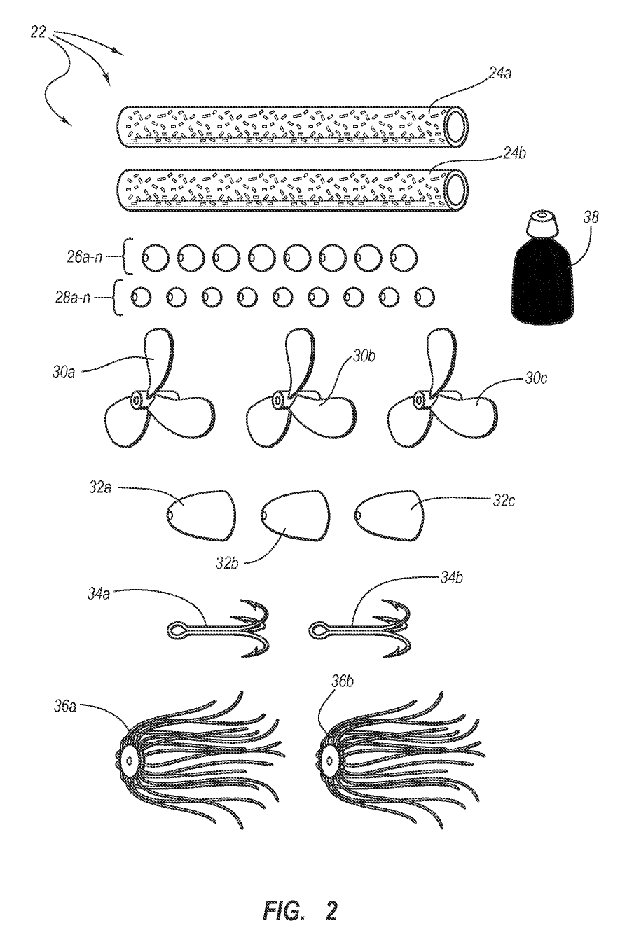

As previously discussed, fishing lure 10 is configured to be customizable by the user. Fishing lure 10 can be created from a variety of different components provided in connection with the modular fishing lure system. As a result, the user can use creativity and different luring strategies in creating the fishing lure system. For example, a variety of different colors of beads, filler glitter, or the like can be inserted into body 14 of fishing lure 10. Additionally, the juxtaposition of different components of fishing lure 10 can be changed. For example, a propeller can be positioned at the proximal end of the fishing lure instead of between the body and the hook of the fishing lure. The customizable aspect of the fishing lure will be discussed in greater detail with reference to FIGS. 2-6. According to another embodiment of the present invention, fishing lure 10 does not utilize a leader, but rather the hook is secured directly to the primary line utilized during angling.

FIG. 2 is a component view of a fishing lure system 22 according to one embodiment of the present invention. In the illustrated embodiment, fishing lure system 22 includes a variety of different components which can be assembled by a user in a large variety of different types, shapes and configurations to create a customizable fishing lure, as illustrated in FIG. 1. In the illustrated embodiment, fishing lure system 22 comprises tubes 24a, b, stopper beads 26a-n, filler beads 28a-n, propellers 30a-c, heads 32a-c, hooks 34a, b, flanges 36a, b, and filler 38.

In the illustrated embodiment, tubes 24a, b can be utilized to provide the body of the fishing lure. By providing both a tube 24a and a tube 24b, the user is provided with different options in creating the configuration of the fishing lure. For example, tubes 24a and 24b can have different colors or color patterns. Stopper beads 26a-n are adapted to be positioned between different components of the fishing lure. For example, a stopper bead 26a can be positioned at one end of tube 24a and a second stopper bead 26b can be positioned at the opposite end of tube 24a to effectively provide sealing and separation between tube 24a and other components positioned adjacent tube 24a. Filler beads 28a-n can be positioned along the length of one of tubes 24a, b to provide color in the tube. For example, in the illustrated embodiment, tubes 24a, b are substantially transparent in nature while having some color or glitter fleckings on the surface or in the matrix of the material from which tubes 24a, b are constructed. By positioning filler beads 28a-n along the length of one or both tubes 24a, b additional color and complexity can be added to the configuration of the body of the fishing lure.

Propellers 30a-c can be provided in a variety of positions relative to the body of the fishing lure to provide action to the fishing lure that resembles normal action of the prey or an enemy of the fish. Additionally, as previously discussed, propellers 30a-c can create turbulence in the water to further attract fish. Heads 32a-c are also provided in connection with the modular fishing lure system 22. Heads 32a-c can be provided at a variety of different points along the length of the fishing lure, including the front end of the fishing lure, the back end of the fishing lure, and a variety of positions in between. Heads 32a-c have a conical configuration to facilitate directional movement through the water as desired by the user.

Hooks 34a and 34b are also provided in connection with fishing lure system 22. By providing a plurality of hooks 34a, b, the user has greater flexibility in positioning hooks along the length of the fishing lure to catch fish that may contact different portions of the fishing lure during the angling experience. Ornamental flanges 36a, b are also provided in connection with fishing lure system 22. By providing a plurality of ornamental flanges, color and movement can be added to the fishing lure system to more closely replicate the movement of a living organism or to provoke action by a fish. Filler 38 comprises a colored liquid, glitter, or the like which can be utilized with different components of the fishing lure to add additional glitter, color, or patterning to the fishing lure in connection with different angling strategies.

As will be appreciated by those skilled in the art, a variety of types and configurations, and a number of different components can be utilized in connect with the fishing lure system without departing from the scope and spirit of the present invention. For example body systems can be any shape size and color other than those that are depicted in FIG. 2. In another embodiment, spinners are provided in addition to the propellers illustrated in FIG. 2. In another embodiment, a plurality of body components having the shape of a minnow or small fish and of different colors, shapes and/or sizes are provided which can be combined with other components of the fishing lure system to allow an angler to create customizable fishing lures. According to another embodiment of the present invention, the body of the fishing lure is provided utilizing a weight, bead, or component other than a tube. According to another embodiment of the present invention, each of the different types of components is provided in multiple colors allowing the user to utilize different color patterns in assembling a fishing lure. For example, according to one embodiment of the present invention separate propellers are providing having a blue color pattern, a yellow color pattern, a red color pattern, and a green pattern allowing the user to select different propellers that match the overall color pattern of the fishing lure being assembled. According to another embodiment of the present invention, different propeller configurations which provide varying movement and speed of rotation can be selected by a user.

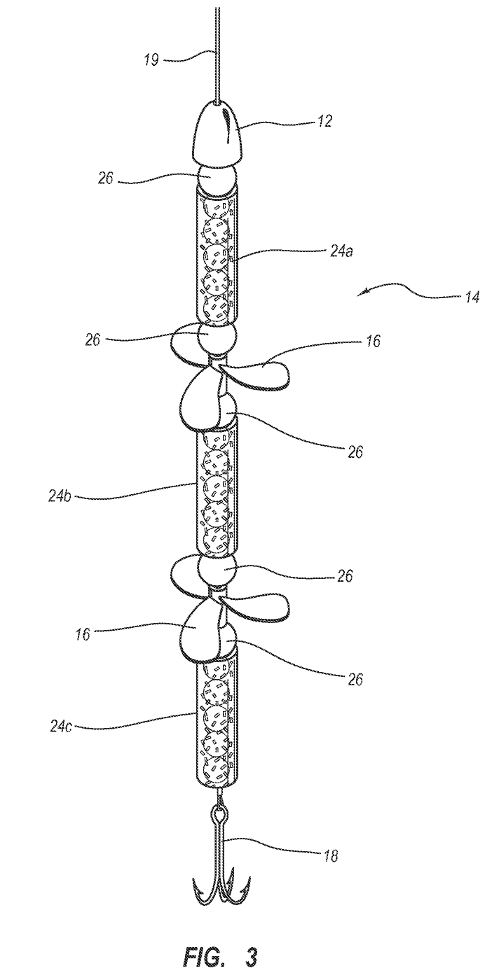

FIG. 3 is a perspective view of a fishing lure according to an alternative embodiment of the present invention. In the illustrated embodiment, a user has utilized components of the fishing lure system 22 depicted in FIG. 2 to create a fishing lure having a different design from that illustrated in FIG. 1. In the illustrated embodiment, a head 12 is positioned at the proximal end of fishing lure 10. A stopper bead 26a is positioned distally to head 12. A first tube 24a is positioned distally to stopper bead 26. Another stopper bead 26 is positioned proximally to tube 24a. A plurality of filler beads are positioned along the length of tube 24a to provide color and desired patterns along the length of tube 24a. Additionally, the presence of filler beads along the length of tube 24a can change the flexibility and action of tuber 24a when forces are exerted on tube 24a.

A propeller 16 is positioned between adjacent stopper beads 26 distally to tube 24a. As previously discussed, propeller 16 provides action and movement to fishing lure 10. A secondary tube 24b is positioned distally to propeller 16 and adjacent stopper beads 26. Tube 24b has a similar length and configuration to tube 24a. Additionally, tube 24b is filled with filler beads in a manner much like that of tube 24a. A propeller 16 is positioned between adjacent stopper beads 26, distal to secondary tube 24b. Positioned distally to the secondary propeller and bead combination is a tertiary tube 24c. Tertiary tube 24c has a similar length and configuration to primary and secondary tubes 24a, b. Finally, a hook 18 is positioned at the terminal distal end of fishing lure 10. The configuration of the fishing lure of FIG. 3 illustrates the greater variability provided by the fishing lure system 22 depicted in FIG. 2. For example, beads of different colors can be inserted into the separate tubes 24a, b, and c providing for different color patterns along the length of the fishing lure of FIG. 3. Additionally, first and second propellers 16 are provided, creating a different juxtaposition and motion of the fishing lure than that of the fishing lure of FIG. 1.

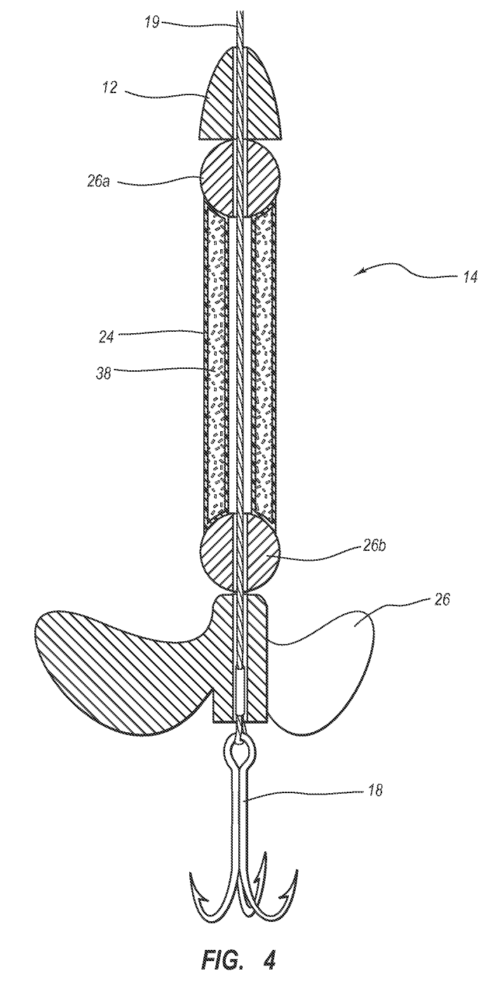

FIG. 4 is a cross-sectional view of a fishing lure according to one embodiment of the present invention. In the illustrated embodiment, it can be seen that leader 19 is positioned along the entire length of the fishing lure. Leader 19 threads through a bore in head 12. From head 12, the leader 19 is threaded through a bore in the head of the solid surface body of stopper bead 26a. The leader 19 is then threaded along the length of tube 24.

In the illustrated embodiment, tube 24 is a double-walled tube having an intermediate space which can be filled by a filler 38. In the illustrated embodiment, filler 38 comprises a glitter or other colored matrix which can be inserted into the intermediate space between the walls of tube 24. A secondary stopper bead 26b is positioned at the distal end of tube 24. Leader 19 is threaded from tube 24 through the solid surface of stopper bead 26b. A propeller 30 is positioned distally to stopper bead 26b. The juxtaposition between propeller 30 the body system facilitates proper and substantially frictionless rotation of propeller 30 as the fishing lure is drawn through the water. Leader 19 runs along the length of propeller 30 and the body system and is attached to hook 18. A component is positioned on leader 19 on the internal portion of propeller 30. The component allows for maintenance of the position of hook 18 relative to the other components of fishing lure 10 in the absence of excessive force being exerted on hook 18. When a fish or other mechanism attaches to hook 18, the leader is pulled from the body of the fishing lure such that hook 18 can move independently and freely from the other components of the fishing lure depicted in FIG. 4.

As will be appreciated by those skilled in the art, a variety of types and configurations of different fishing lures can be utilized without departing from the scope and spirit of the present invention. For example, in one embodiment, the eyelet of the hook is actually positioned within one or more components of the fishing lure such that the hook is secured within the fishing lure until it is contacted by a fish. According to another embodiment of the present invention, the beads can be clear, transparent, opaque, comprised of color material, clear having colored material embedded therein, or other variations to provide selectable and modifiable alternatives in the construction of the lure.

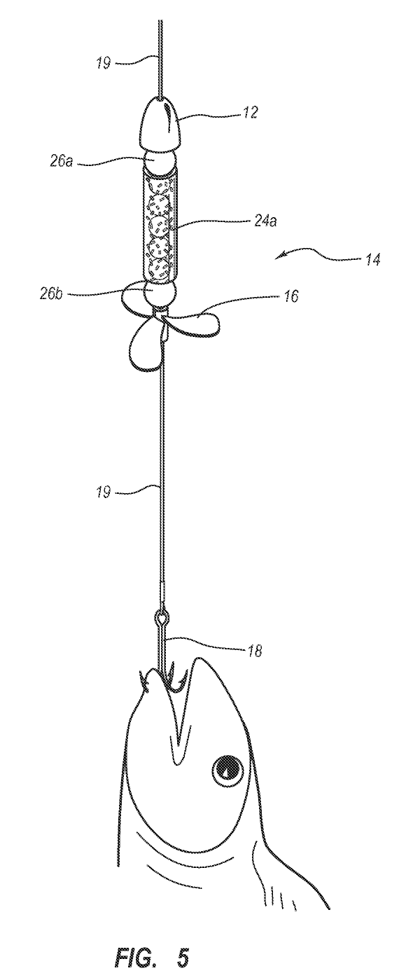

FIG. 5 is an illustrative view of a fishing lure that has been attacked by a fish and in which the fish has been captured by hook 18. In the illustrated embodiment, it can be seen that hook 18 has substantially been pulled away from fishing lure 10. Hook 18 is still fixably secured to leader 19 in a manner that the fish can be pulled in by the angler. The potential to separate hook 18 from the fishing lure and the other components of the fishing lure subsequent to the hook being grabbed by the fish helps to prevent inadvertent releasing of the fish subsequent to rolling, twisting, or other movement of the fish that can occur. Additionally, forces that may otherwise result in damage to the lure, the hook, result in loosening of the hook from the fish are minimized as such forces can easily be absorbed by the portion of leader 19 between hook 18 and the other components of the fishing lure.

A variety of types and configurations of fishing lures can be utilized without departing from the scope and spirit of the present invention. For example, in one embodiment, the hook 18 does not separate from the other components of the fishing lure. In another embodiment, the amount of separation between hook 18 and the other components of the fishing lure is controlled by a stopper or other mechanism which limits the length of leader which can be pulled through the components of the fishing lure. In another embodiment, the amount of leader that can be pulled through the fishing lure to allow for separation between hook 18 and the other components of the fishing lure are not controlled, but rather allowed to operate as a natural function of the particular angling situation. In another embodiment, the hook can release from the fishing lure to allow for retrieval of the fishing lure in the event that the hook is inadvertently snagged on a log, rock, or other obstacle in the fishing environment.

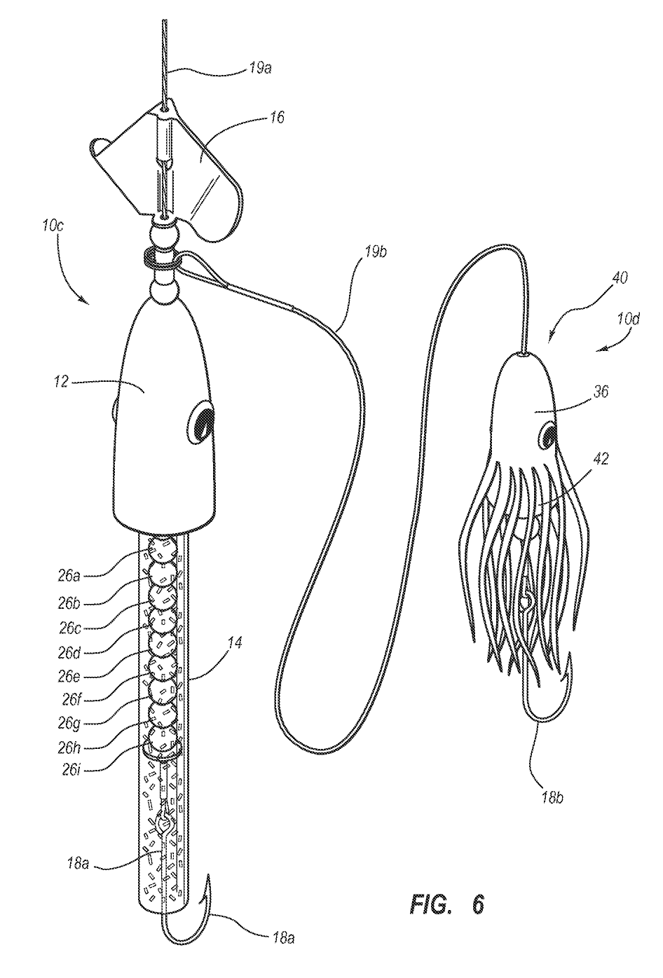

FIG. 6 is a perspective view of yet another embodiment of the fishing lure, according to one embodiment of the present invention. In the illustrated embodiment, a primary fishing lure 10c and a secondary fishing lure 10d are provided. In the illustrated embodiment, primary fishing lure 10c is a larger and more dominant feature of the overall fishing lure system. Primary fishing lure 10c comprises a propeller 16 which is positioned at the proximal end of fishing lure 10c. Additionally, propeller 16 comprises a two-blade propeller, as opposed to the three or more blade propellers depicted in FIGS. 1-5. Head 12 is positioned distally to propeller 16. Head 12 comprises a lead weight which has an aerodynamic configuration, but a greater weight, which facilitates a moderated movement along the length of fishing lure 10c.

Body 14 comprises a tube member having a plurality of filler beads 28a-i. Optionally, body 14 can have a plurality of color, shape and design patterns. Hook 18a is configured such that a portion of the hook is positioned inside body 14, while the tip of the hook is positioned external to tube 14. The circular eyelet of hook 18 is positioned within body 14 such that it engages the inner surfaces of the tube of body 14. When a fish attaches to the barb end or tip of hook 18a, the hook is pulled from the body 14 and leader 19a provides separation between hook 18a and fishing lure 10c. A secondary leader 19b is secured between propeller 16 and head 12 of fishing lure 10c. Secondary leader 19b is secured to a secondary fishing lure 10d. Secondary fishing lure 10d comprises a buoyant member 40, which is adapted to bounce, float, and gyrate behind primary fishing lure 10c. Secondary fishing lure 10d comprises a buoyant member 40, a flange 36, a body 42, and a hook 18b. The buoyant nature of the buoyant member 40 allows for increased movement of secondary fishing lure in a manner that attracts fish to one or both of secondary lure 10d and primary lure 10c. Additionally, a flange 36 is positioned around body 42. Flange 36 provides additional color and movement to the secondary lure 10d that can attract fish to the fishing lure system.

As will be appreciated by those skilled in the art, the size, configuration, and juxtaposition of elements utilized with the modular fishing lure system and customizable fishing lures can vary without departing from that depicted in the current drawings. For example, the length of the leaders can vary from that which is depicted. Additionally, the size and configuration of the flanges, the variable colors, the size and configuration of beads, body designs and other known elements not depicted (feathers, hair, striping, threads, foam, and the like), can be utilized without departing from the scope and spirit of the present invention.

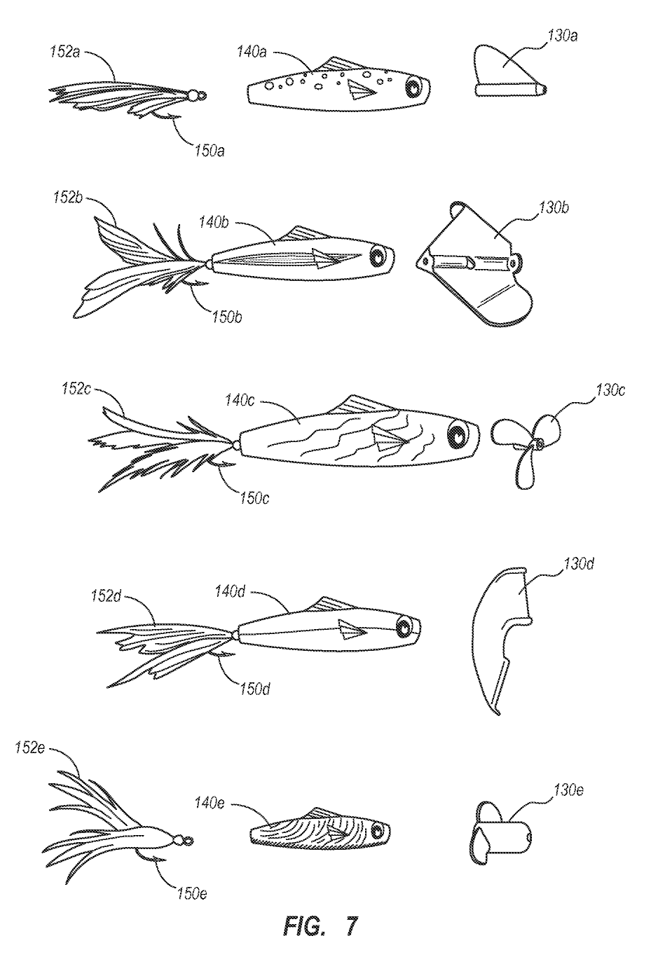

FIG. 7 illustrates components that can be utilized to create a customizable fishing lure according to one aspect of the present invention. In the illustrated embodiment, propellers 130a-e, bodies 140a-e, and hooks 150a-e are provided. Propellers 130a-e provide a variety of propeller configurations that can be utilized by a user to create varying amounts of movement, speed of movement and visual impression of the fishing lure. For example, propeller 130a comprises a single blade design. The single blade design of propeller 130a can create an irregular pattern of movement which can be indicative of an injured fish. Propeller 130b comprises a double blade in a reverse triangular configuration. The size of propeller 130b is comparatively large to the body of the fishing lure. The double blades of propeller 130b provide a more uniform spinning action while the large size of propeller 130b increases the amount of vibration relative to a smaller size propeller.

In the illustrated embodiment, propeller 130c comprises a three blade rotary design. Propeller 130c is somewhat smaller in comparison to the body of the lure with which is to be utilized. Propeller 130c provides a uniform spin and more rapid vibration frequency that may be associated with a fish fleeing from a predator. Propeller 130d comprises a double paddle design with large blade flanges. Propeller 130d also had a relatively large size in comparison with the body of the lure with which it is to be utilized. Propeller 130d is configured to give a large amount of side to side movement of the fishing lure. Propeller 130e comprises an annular double blade design. Propeller 130e has a larger overall mass and circumference that facilitates a smooth and uniform action of the fishing lure through the water. In the illustrated embodiment, propellers 130b and 130d are formed from a reflective metal material that can operate as an attractant to feeding and/or territorial game fish. While propellers 130a, 130b and 130d have an opaque plastic design that can be formed from a variety of materials and in a variety of colors.

As will be appreciated by those skilled in the art, the size, shape color and configuration of propellers 130a-e are illustrative of propeller designs that can be utilized with a customizable fishing lure of the present invention and should not be considered to be limiting in nature. A variety of types and configurations of propellers and/or movement inducing mechanisms can be utilized with the customizable fishing lure system of the present invention without departing from the scope and spirit of the present invention. According to one embodiment, a customizable propeller is provided. For example, the propeller can have bendable or removable blades that allows the user to change the action of the fishing lure while using a single propeller. According to another embodiment of the present invention, a spoon, spinner, or other mechanism is provided in place of a propeller. According to yet another embodiment of the present invention, different sizes of propellers having a similar shape are provided.

In the illustrated embodiment, a pluralities of bodies 140a-e are provided. Bodies 140a-e are each designed to look and move through the water like a minnow or a small fish. In the illustrated embodiment, the size, shape and coloration of each of bodies 140a-e vary. For example, body 140a can have a green dorsal region, a pink side region and a white belly region. Additionally, body 140a has a plurality of spots positioned on different regions of the body. In contrast, body 140b can have a blue dorsal region and a silver belly region while also being devoid of spots. Similarly, body 140e is much smaller and darker than either body 140a and 140b. By providing bodies having different colors, designs, visual impressions, shapes, and sizes, a user can substitute one of bodies 140a-e for a different one of bodies 140a-e to achieve a different size, action, visual impression and overall size of the fishing lure system.

As will be appreciated by those skilled in the art, a variety of components and characteristics of the body of the fishing lures can be varied without departing from the scope and spirit of the present invention. For example, in one embodiment, the degree of resilience of the body of the fishing lure is variable to provide a more fluid or more rigid movement of the fishing lure through the water. According to another embodiment of the present invention, the height, width, length weight, buoyancy or material properties of the body vary from one body to another body. According to yet another embodiment of the present invention, the size of the dorsal fin, caudal fins, the presence or absence of fins, the size or shape of the eyes or other configuration of the body of the fishing lure are variable.

In the illustrated embodiment, a plurality of fishing hooks 150a-e are provided. Fishing hooks 150a-e are configured to be secured to the bodies 140a-e and propellers 130a-e by the line or leader that is run through each of the components. In the illustrated embodiment, when a fish is hooked by one of hooks 150a-e, the one of hooks 150a-e can be separated from the body of the fishing lure (e.g. one of bodies 140a-e). Hooks 150a-e can be provided with varying sizes and configurations including a treble hook, a three pronged hook, a hook having one or more barbs, a barbless hook, a single prong hook etc.

In the illustrated embodiment, a plurality of feathers 152a-e are provided in connection with hooks 150a-e. Feathers 152a-e can have different color patterns, sizes shapes, selected feather combinations etc. In this manner, a user can select from a variety of feather configuration to further customize the ornamental and performance of the fishing lure. For example, according to one embodiment of the present invention, the feathers 152a associated with hook 150a can comprise the colors red, black and yellow and have a more streamlined and hydrophilic characteristic. In contrast, feathers 152b associated with hook 150a can comprise the colors yellow, light pink and neon pink and have a more flaring and hydrophobic characteristic. Similarly, feathers 152c, 152d and 152e can have varying material properties and visual designs to provide a selection and variety in connection with the other components of the fishing lures.

As a user is preparing a fishing lure either at home or in a fishing environment, the user can select from a variety of propeller designs 130a-e, body designs 140a-e and hook designs 150a-e. As the user experiments in the fishing environment with different customizable fishing lure designs, the user may determine that one or more modifications to the fishing lure may be needed. For example, a user may determine that more or less action is needed with a particular body and hook design. The user can quickly and efficiently, substitute the selected propeller mechanism for a propeller mechanism which is larger or has a larger blades. In another situation, a user may decide the amount of action of the fishing lure is appropriate, but that a darker and smaller body should be utilized. According to another embodiment of the present invention, primary and secondary lures can be formed utilizing the components of the fishing lure system. The number and variety of components thus provide a easily customizable and modifiable design that can be utilized by users to quickly and efficiently exchange or substitute one or more components of the fishing lure design.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A fishing lure system which allows a user to create customizable fishing lures with greater flexibility and creativity while also being modifiable in the fishing environment allowing the user to alter a lure as needed while the user is fishing, the fishing lure system comprising;
at least one resilient body being configured to secure additional components of the fishing lure system and being adapted to facilitate movement of a fishing lure through the water, the at least one resilient body having a first configuration;
a second resilient body being configured to secure additional components of the fishing lure system and being adapted to facilitate movement of a fishing lure through the water, the second resilient body having a second configuration, wherein the user selects at least one of the first resilient body and the second resilient to form a form a customizable fishing lure;
one or more propellers positioned adjacent the body in a manner allowing rotation of the propeller to provide movement to one or more components of the fishing lure;
one or more hooks configured to be releasably secured at one or more different positions of the fishing lure such that when a fish is captured by the hook the hook releases from secure coupling with the other components of the fishing lure.

2. A customizable fishing lure which is modifiable in the fishing environment allowing the user to alter a lure as needed while the user is fishing, the fishing lure system comprising;
a body comprising a resilient member and providing a substrate for securing additional components of the fishing lure system;
a head having a conical configuration which is adapted to facilitate movement of a fishing lure through the water;
a propeller positioned adjacent the body in a manner allowing rotation of the propeller to provide movement to one or more components of the fishing lure;
one or more color components configured to allow a user to select different color patterns associated with one or more components of the fishing lure system;
a hook configured to be releasably secured at one or more different positions of the fishing lure such that when a fish is captured by the hook, the hook releases from secure coupling with the other components of the fishing lure.

3. A customizable fishing lure system which allows a user to create customizable fishing lures with greater flexibility and creativity while also being modifiable in the fishing environment allowing the user to alter a lure as needed while the user is fishing, the fishing lure system comprising;
a primary lure comprising:
a body comprising a resilient tube and providing a substrate for securing additional components of the fishing lure system;
one or more heads having a conical configuration which is adapted to facilitate movement of a fishing lure through the water;
a propeller positioned adjacent the body in a manner allowing rotation of the propeller to provide movement to one or more components of the fishing lure;
one or more color components configured to allow a user to select different color patterns associated with one or more components of the fishing lure system;
a hook configured to be releasably secured at one or more different positions of the fishing lure such that when a fish is captured by the hook, the hook releases from secure coupling with the other components of the fishing lure; and
a secondary lure linked to the primary lure, the secondary lure comprising:
a buoyant member;
a color component secured relative to the buoyant member;
a hook configured to be secured to adjacent the buoyant member.
